(19) United States
(12) Patent Application Publication
(10) Pub. No.: US 2017/0116384 A1
(43) Pub. Date: Apr. 27, 2017

(54) SYSTEMS AND METHODS FOR COMPUTERIZED PATIENT ACCESS AND CARE MANAGEMENT

(71) Applicant: Jamal Ghani, Flint, MI (US)

(72) Inventor: Jamal Ghani, Flint, MI (US)

(21) Appl. No.: 15/331,802

(22) Filed: Oct. 21, 2016

Related U.S. Application Data
(60) Provisional application No. 62/244,715, filed on Oct. 21, 2015.
(60) Provisional application No. 62/319,274, filed on Apr. 6, 2016.

(51) Int. Cl. G06F 19/00; H04L 29/06

(52) U.S. Cl. CPC G06F 19/3418; G06F 19/325; H04L 63/08; G06F 19/322; G06F 19/328

(57) ABSTRACT

Systems and methods are provided for locating an on-call doctor, specific to a patient's needs, who is readily available for a live confidential patient consultation using a network enabled communication device with a digital camera and microphone. The system facilitates customized matching of patients with doctors to provide higher quality and faster delivery of medical evaluation, diagnosis, and treatment. The systems and methods transmit results through a secure connection and manage a referral process whereby a referring doctor refers a patient to another provider, laboratory, facility, or store for a particular procedure, order, analysis, or care. The referrals may be based on specialties and availability. The system relates particularly to the fields of medicine, where doctors can perform online consultations and provide a diagnosis, treatment recommendations, recommendations for further analysis, triage and/or provide follow up on-call care.

### BACKGROUND

This application claims priority to U.S. Provisional Application No. 62/244,715, filed on Oct. 21, 2015 and U.S. Provisional Patent Application No. 62/319,274, filed on Apr. 6, 2016, both pending, the disclosures of which are incorporated herein by reference.

### FIELD

The present disclosure relates generally to a platform for mobile-based medical collaboration services. More particularly, the disclosure relates to systems and methods for providing mobile-based interactive and collaborative patient care platforms, network, and treatment systems which allows both the patient, health care professional, and specialist participant in a high level of real time interactivity without regarding to geographic location.

### BACKGROUND

Networked patient care services are generally known. However, they are limited by the constraints of the Internet and the vagaries of participant computers. The market lacks a platform for patient care that allows patients, medical professionals, and their staff to quickly and efficiently interact with each other and third parties.

Currently, there are many disparate patient care services that medical professionals and patients can use. Often, these systems do not communicate with one another and do not share information with one another. This can lead to serious consequences in patient care. For example, miscommunication or a lack of communication between medical professionals involving a patient can lead to disastrous treatment indications and comorbidities.

Some attempts have been made at creating online patient care platforms, however they have been generally unsuccessful. One problem facing the prior art platforms is the lack of patient provided input. For example, existing patients have very little access to their own medical records because they exist in non-electronic form. Furthermore, they have no way to update their medical records without directly interfacing with a medical professional. Another issue with existing online patient care platforms is the lack of usability for patients. For example, many platforms are simply an information repository that the patient can access.

One piece of the proposed platform includes a telemedicine component. The American Telemedicine Association (ATA) defines telemedicine as the use of medical information exchanged between different sites using electronic communication to generally improve a patient's health. Along with telemedicine, the term, “Tele-health” is used in a broader sense and may or may not include clinical services, e-health stations for patients, remote monitoring of vital signs, continuing medical education, and call-centers for nurses.

The World Health Organization has pinpointed the following advantages to telemedicine:

a) It reduces the waiting period for a patient to receive medical attention by a licensed healthcare professional;

b) It reduces the cost of medical treatment by diminishing travel expenses for patients to locations that offer the specialized care they require;

c) It increases the access to healthcare services by connecting a wide variety of specialists that can each speak to their particular area of expertise. The amount of healthcare professionals is only limited to how many of them are found in any given location that possesses a telemedicine unit;

d) It improves the perception of the type of healthcare that is provided in remote communities that do not always have access to specialists, when said communities are given access to these networks.

Telemedicine services are varied and serve a variety of purposes. There are systems to monitor patients at home, other systems monitor patients at a healthcare facility, for instance, patients in a hospital or in an intensive care unit.

Certain systems provide remote diagnosis and medical assistance services. To do so, they transmit audio, video and biomedical data. These systems aim to connect two or more healthcare professionals within specialized facilities so that a service may be provided.

Patients that live in remote or isolated communities may receive better healthcare services. The attention they receive can be more frequent and/or more specialized. This directly improves the quality of the healthcare services provided and benefits the health conditions of the inhabitants of said community.

Another advantage to telemedicine is that it allows severe medical conditions to be treated quicker, hopefully avoiding patient deaths or prolonged periods of rehabilitation. The different benefits of prompt treatment—within 60 minutes in a personal or virtual form—by a healthcare professional is widely acknowledged in the medical community.

Of the different telemedicine systems currently in existence, patents and patent applications have been issued that show the current State of the Art.

An example of a telemedicine system is the one found in U.S. Pat. No. 5,987,519. It describes a telemedicine service that captures data, video, and audio, which is later retrieved, in order to exchange medical information between a central monitoring hub and a remote patient portal. The system of said patent states that: 1) The Telemedicine System based on data transmission units sent between a central hub and a remote patient portal that can be exchanged through different networks; 2) A variety of biomedical devices are connected to the remote patient portal, which then relays the information it collects to the central control unit; 3) The patient monitoring unit also includes videoconference interface that operates with another videoconference interface to exchange audio and video; 4) The information captured in the remote unit and retrieved in the central unit; 5) The control unit in the central monitoring station displays clinical information, and videoconference information, and processes each of them separately.

The telemedicine service described in said patent is limited to a monitoring system for individual patients that require a patient monitoring unit in their homes; it is not thereby designed to provide remote consultation, diagnosis and medical assistance between different healthcare professionals to multiple patients.

Likewise, even though said monitoring system connects different biomedical devices so that patient information may be sent to the central monitoring unit, it is limited in the sense that it has to select the source of information and does not allow for the simultaneous display of audio and video.

Another example of a telemedicine system is the one found in the Patent Application Publication US 2011/0178373 which describes a telemedicine system which consists in: 1) A method to operate a Telemedicine Base Unit connects to a remote attention site; 2) The transmission of a signal generated by a piece of medical equipment to the remote unit; 3) The reception, in the base unit, issues instructions for the operation of the piece of medical equipment from the remote unit, in accordance with the information that was originally transmitted; 4) The instructions provide a guide to operate a piece of medical equipment identified as the signal generator; 5) The method also comprises the transmission of audio and video from the telemedicine unit to the remote assistance unit; 6) Patient medical data is also transmitted to the remote site; 7) Reception of graphic instructions from the remote site which are annotated over the signal generated by the connected piece of medical equipment. Annotations over sent graphic instructions.

The system and methods of telemedicine described in the referred patent application publication presents a fundamental disadvantage in the sense that it is a system and a methodology that is used exclusively to provide remote instructions in the use of a piece of medical equipment connected to a telemedicine unit by a specialist located in a central hub using video, audio and data generated by a remote unit. It is not designed to provide consultation, diagnosis, and/or medical assistance by health care professionals The disclosure description states that the described unit may be used with a variety of biomedical devices, but it does not show that it may be used by several biomedical devices in a simultaneous fashion. The design of this disclosure is clearly limited to a sole unit seeing as the system operates automatically once the single piece of medical equipment is connected.

Another example of a prior art telemedicine system and methodology to provide remote e-Health services is the one found in U.S. Patent Application US 2012/0179479 that describes Systems and Methodologies for Remote E-Health Services which consists in: 1) A system to provide remote medical consultation between a Medical Booth and a remote Medical Call Center (MCC); 2) The medical booth is able to place medical equipment on a patient in response to instructions issued remotely by a healthcare professional; 3) The MCC can graphically display patient data or information; 4) Two-way communication between the MCC and the Booth, including transmitting data and videoconference.

The system mentioned above is limited for diagnostic and medical assistance purposes because it was designed for a patient to enter a booth in which he or she may have access to medical equipment that will relay his information to a central station. The booth or kiosk consists of a spot that recollects biomedical data in order to be analyzed by a central hub. It does not handle images and data in a simultaneous fashion and it does not have an annotation system that allows the patient and healthcare specialist to interact and ultimately provide a diagnosis.

Considering the current state of this field of knowledge, it would be advantageous if a telemedicine system existed that was designed to provide consultation, diagnosis and medical treatment service to patients, using information and telecommunication technologies that allow simultaneous and independent display of information. A telemedicine service designed for these purposes, would enable specialized physicians located in highly specialized or better equipped medical facilities to aid healthcare professionals located in different areas, with consultation, diagnosis and medical assistance.

This technique allows healthcare specialists located in different locations to, using telemedicine units (such a mobile phone), simultaneously display and transmit all medical information of a patient through audio, video and data from any geographical location. Likewise, the units should transmit and display the medical history of a patient and enable videoconference with units operated by specialists.

It would be convenient for healthcare specialists to be able to receive and make use of, independently of any actions carried out by healthcare professionals elsewhere, all information including data, video, and audio, generated by all biomedical devices connected to the telemedicine unit of the patient; to generate annotations and give visual indications over the data and video to the remote unit; to have access to all the information contained in the medical history; and along with a videoconference, to carry out remote medical consultation in order to reach a diagnosis and propose a form of treatment for the patient.

Healthcare professionals are often limited to learning each patient's status strictly through patient initiated events, such as an emergency visit, an urgent care visit, a phone call, or other patient initiated event that results in delivery of the patient's latest medical data. Even with the current availability of remote monitoring devices that store and transmit medical data from a patient's home to a clinic, the healthcare professional must still wait for medical information whose arrival depends on the patient's initiative.

It would be advantageous to provide a platform that incorporates a feature set designed specifically for healthcare, including integrated healthcare eligibility checking, fee and co-pay collection, electronic prescribing, coding, electronic referrals, and messaging forms designed to facilitate appointment scheduling, prescription refills, reporting test results and other routine transactions. It would be advantageous to provide a HIPAA-capable system, incorporating a complete audit trail that can be implemented quickly and easily by healthcare professionals and organizations without significant infrastructure investments. It may also be an advantage to provide patients with medically reviewed healthcare information, such as preventive health information, self-care and preventive care information, chronic care management, and customizable, targetable patient newsletters over the same platform.

Thus, there is a need for a patient health platform that provides real-time communication between the patient and a healthcare professional as well as patient health records and enterprise health information systems. Such a system would provide both patients and healthcare professionals with the most up-to-date information. Moreover, patients could access an informed medical professional in real-time.

### BRIEF SUMMARY

Accordingly, to address the problems found in the conventional systems, described herein are systems and methods that provide platform solutions to enable telemedicine consults between patients and desired physicians based on the availability of the physicians. The systems and methods allow delivery of the same high-quality standard of care that is provided in an office setting while also saving time, money, increasing efficiency and increased access to healthcare professionals. Furthermore, the described systems and methods provide platform solutions that add value beyond their constituent parts. Although telemedicine is a major component of this platform, it is not the only component, and some platforms may have a limited or reduced telemedicine component.

The system may include one or more servers that maintain one or more databases of physicians and specialists. Patients may register with the server and login to search for a desired physician, for example, the patient's primary physician or a specialist in a particular field. In another example, the server may suggest available physicians to the patient based on location, availability, and rating. In yet another example, the server may alert available physicians and allow the physicians to determine whether to initiate contact. When the desired physician or patient is identified, and if the physician and patient are available, the server may establish a rich multimedia session between the patient and the physician. Patient information can be summarized and provided to the physician in advance of and during the multimedia session. After the consultation, the physician may document the medical encounter in an approved electronic medical record, which can be stored and accessed later. The medical progress note may be sent to the patient, for example via a secure email. Alternatively, any treatment plan or prescription can be provided to the patient and also recorded and stored for later delivery to a primary care physician or consolidation with the patient's medical history or other electronic health record. Payment to the physician may also be managed by the server. Payment can be made directly by the patient or through an insurance plan to which the patient belongs.

The present disclosure provides a mobile-based platform for facilitating collaborative interactions via the Internet or an intranet. The system may include a system server configured for brokering communication between the physician, the patient, and a specialist.

The platforms disclosed herein may be technology-agnostic. For example the platform may be accessed through mobile devices that run various operating systems, a variety of computing devices, and with a variety of electronic medical records. By providing mobile access as well as desktop access to care, patients are not forced to take time off to see a physician or to seek medical advice. Removing this time constraint is important, because the average time of missed work to see a family practice physician is approximately four hours. The platforms disclosed herein can eliminate this long wait. In addition, patients and healthcare professionals may use the platform 24 hours a day, seven days a week to access needed clinical care.

In addition, the platform will allow medical professionals to redirect emergency room and urgent care utilization to more appropriate modes of care—thereby providing significant savings and higher quality care. For example 70% of primary care visits and 40% of emergency room visits are medically necessary and could be redirected through the platforms disclosed herein.

One embodiment of the present disclosure may be described as a system for computerized patient access and care management. The system may comprise a user endpoint device having a display and an audiovisual receiver in communication with a processor, a physician endpoint device having a display and an audiovisual receiver in communication with a processor, a specialist endpoint device having a display and an audiovisual receiver in communication with a processor, and a care management server in electronic communication with the user endpoint device, the physician endpoint device, and the specialist endpoint device.

The care management server is in electronic communication with one or more electronic user authentication databases, one or more electronic patient information databases; and one or more electronic physician information databases.

The processor of the user endpoint device is configured to authenticate a patient by transmitting authentication data received at the user endpoint device to the care management server, transmit a multimedia session request to the care management server, receive a set of available physicians for a multimedia session, negotiate the multimedia session with the physician endpoint device via the care management server, transmit audiovisual data to the physician endpoint device from the audiovisual receiver of the user endpoint device, and receive and display audio visual data from the physician endpoint device using the display of the user endpoint device.

The processor of the physician endpoint device is configured to authenticate a physician by transmitting authentication data received at the physician endpoint device to the care management server, negotiate a request for the multimedia session with the authenticated user endpoint device via the care management server, receive patient history data from the care management server corresponding to the authenticated patient, transmit audiovisual data to the user endpoint device from the audiovisual receiver of the physician endpoint device, and receive and display audio visual data from the user endpoint device using the display of the physician endpoint device.

During the multimedia session, the processor of the physician endpoint device may be configured to transmit a second multimedia session request to the care management server, receive a set of available specialists for the multimedia session from the care management server, and negotiate the multimedia session with the specialist endpoint device via the care management server.

The processor of the specialist endpoint device is configured to authenticate a specialist by transmitting authentication data received at the specialist endpoint device to the care management server, negotiate a request for the multimedia session with the authenticated physician endpoint device and the authenticated user endpoint device via the care management server, receive patient history data from the care management server corresponding to the authenticated patient, transmit audiovisual data to the physician endpoint device and the user endpoint device from the audiovisual receiver of the specialist endpoint device, and receive and display audio visual data from the user endpoint device and physician endpoint device using the display of the specialist endpoint device.

The care management server is configured to receive authentication data from the user endpoint device, physician endpoint device, or the specialist endpoint device, compare the received authentication data to the one or more user authentication databases, transmit an authentication signal to the user endpoint device, physician endpoint device, or the specialist endpoint device from which the authentication data was received, receive a multimedia session request from the user endpoint device, transmit to the user endpoint device a set of available physicians from the one or more physician information databases corresponding to one or more authenticated physician endpoint devices. transmit to the physician endpoint device patient history data from the one or more patient information databases corresponding to the authenticated patient, receive a multimedia session request from the physician endpoint device, transmit to the physician endpoint device a set of available specialists from the one or more physician information databases corresponding to one or more authenticated specialist endpoint devices, and transmit to the specialist endpoint device patient history data from the one or more patient information databases corresponding to the authenticated patient.

In one embodiment, the processor of the user endpoint device is configured to provide patient history data to the authenticated patient using the display of the user endpoint device. The processor of the user endpoint device may also be configured to receive new patient history from the user endpoint device and transmit the new patient history to the care management server. In such embodiments, the processor of the care management server is configured to receive the new patient history from the user endpoint device, process the new patient history according to pre-determined business rules, and store the processed new patient history in the one or more patient information databases.

In some embodiments, the patient information database contains insurance information corresponding to each patient and the processor of the care management server is configured to analyze the insurance information with respect to pre-determined business rules to determine if the patient is qualified for free medical care.

In other embodiments, during the negotiation of the multimedia session with the physician endpoint device via the care management server, the processor of the care management server is configured to place the authenticated patient in a session queue.

In some embodiments, during the negotiation of the multimedia session with the physician endpoint device via the care management server, the processor of the care management server is configured to transmit the session queue to one or more authenticated physician endpoint devices and receive a selection corresponding to a patient in the session queue from the one or more authenticated physician endpoint devices.

In other embodiments, the care management server receives updated patient history information from the physician endpoint device or the specialist endpoint device and stores the updated patient history information in the one or more patient information databases.

In other embodiments, a medical diagnostic device is in electronic communication with the user endpoint device, the medical diagnostic device configured to provide real time patient information to the user endpoint device. The user endpoint device is further configured to transmit the real time patient information from the medical diagnostic device to the care management server.

In some embodiments, the care management server is configured to receive prescription requests from the physician endpoint device or the specialist endpoint device. In another embodiment, the user endpoint device is configured to receive geographic location and transmit the geographic location to the care management server.

### DESCRIPTION OF THE DRAWINGS

For a fuller understanding of the nature and objects of the disclosure, reference should be made to the following detailed description taken in conjunction with the accompanying drawings, in which:

FIG. 1 is a network diagram illustrating an example system for enabling telemedicine consults according to an embodiment of the disclosure.

FIG. 2 is a diagram illustrating various server modules according to an embodiment of the disclosure.

FIG. 3 is a flowchart illustrating a consultation according to an embodiment of the disclosure.

FIG. 4 is a hardware diagram illustrating a physician, patient, or specialist unit according to an embodiment of the disclosure.

FIG. 5 is a flowchart illustrating a multi-party consultation and post-consultation according to an embodiment of the disclosure.

FIG. 6 is a flowchart illustrating a telemedicine consultation between three parties according to an embodiment of the disclosure.

FIGS. 7A and 7B are drawings illustrating one embodiment of a mobile device application used to communicate with a disclosed platform.

FIGS. 8A and 8B are drawings illustrating one embodiment of a mobile device application, specifically FIG. 8A shows a patient detail screen and FIG. 8B shows a patient reports screen.

FIG. 9 is a drawing illustrating multiple components of the presently disclosed platform.

FIG. 10 is an illustration of one embodiment of the presently disclosed platform, specifically how the platform communicates with third parties.

FIG. 11 is a system diagram illustrating components of the presently disclosed platform.

FIG. 12 is a system data-flow diagram illustrating the flow of data within the presently disclosed platform.

FIG. 13 is a layer diagram illustrating the various layers (application, business, and database) of the presently disclosed platform.

FIG. 14 is a system diagram illustrating the security features of the presently disclosed platform.

FIGS. 15A-D are illustrations of another embodiment of the mobile device application used to manage preferred provider and geographic filtering.

### DETAILED DESCRIPTION

The described embodiments herein may be one component in a more comprehensive healthcare platform. For example, in addition to the patient being able to access live care, the patient may be able to book an appointment, review appointments, view and edit medical history, view and edit health reports, view and redeem prescriptions, view and edit the patient's profile, view and edit family members related to the patient, make donations for providing healthcare to others, viewing medical transactions through the platform, and reviewing messages sent through the platform. Each of these will be described in further detail below.

When a patient or medical professional selects a link associated with a one of the platform options, a server may initiate a routine associated with the option. The platform may advantageously permit viewing of a wide variety of information types including patient-created information stored within the platform's server and patient-related information stored within third-party servers. The patient-created data may be notes and comments relating to the user's health or requests for information. The patient-related information may be portions of the user's medical record and other information created by the health care professionals and staff.

In one embodiment the patient may be able to book an appointment through the mobile platform. For example the patient may be able to book an appointment for lab work through the platform. In another example, the patient may be able to book and in-person appointment with a medical professional. If the medical professional or medical organization is a user of the platform, the patient's may be able to receive real-time information regarding appointment availability. The platform may send reminders to the patient about any upcoming appointments. Likewise, the platform may send reminders to the medical professional or medical organization. The reminders may contain supplemental information or links to information about the patient's, the medical professional, or the medical organization. For example the reminders may contain patient health information, maps to direct the patient to the medical professional, or pre-exam instructions.

Accordingly, a patient may search for healthcare professionals by type using various search criteria (e.g., specialty, cost, gender, practice location by city, state, region, country, proximity to clinic, affiliation, spoken language, and/or physician/hospital quality ranking) or may identify a particular provider for scheduling an appointment, and the customer may be presented with scheduling tools showing open appointments for one or more providers and/or care givers that match the customer's specifications. According to further embodiments, a patient accessing the platform may request appointments for specific days or times at a particular clinic or with a particular medical professional. The centralized scheduling system may send the patient a response indicating which clinic is available that matches the availability of the selected remotely located medical professionals. Alternatively, the centralized scheduling system may send the patient a response indicating which remotely located provider is available at the same time a particular clinic is available.

In one embodiment, the patient may be able to review their currently scheduled appointments. The patient may see these appointments in a calendar display. The patient may be allowed to edit or change those appointments. For example, the patient may be able to reschedule an appointment with a medical professional. The patient may also be able to initiate a life care consultation or a direct message with the medical professional through the appointment calendar.

In one embodiment the patient may have access to their medical history. The patient's medical history may be stored in the platform itself or accessed through a third-party integration. For example, the platform may communicate with a third-party electronic health record, the health records of any associated medical professionals of the patient, or a patient health record. The medical history may contain information from previous interactions with the presently disclosed platform. The medical history may also contain information supplied by the patient. The medical history may also contain information supplied by a medical professional prior to the platform's use. In some circumstances, the patient's access to the medical history may be limited. For example, the patient may be unable to review medical results from testing before a consultation with a medical professional. In another example, the patient may not be able to edit the medical history in order to preserve accurate medical records for the patient. In another example, the patient may be able to supplement the medical history in order to provide additional details.

The patient may have access, in one embodiment, to medical reports. The reports may be related to clinical testing, laboratory results, and medical professional notes. The reports may be displayed in text format or graphical format. For certain numerical and other diagnostic results, the patient's reports may be compared to a baseline or accepted normal range. The reports may be organized by date or by report type, or by any other type suitable for viewing on a mobile device.

Through the platform, the patient may have access to their prescriptions. These prescriptions may be historical in nature, i.e., prescriptions that have already been filled. The prescriptions may also be new prescriptions from a medical professional authorized through the platform. For example, a medical professional may prescribe medication to the patient after a real-time consultation session. The platform may be connected to electronic prescription systems to facilitate the fulfillment of the prescription. The platform may also integrate with pharmacies, including pharmacies located within a prescribed geographical range of the patient.

The patient may also have access to their platform profile. The platform profile may contain biographical information on the patient. The profile may contain other preferences or settings for the platform. The profile may also contain preferences for certain medical professionals or modalities of care. The patient profile may be unstructured information, such as unstructured text notes, or the notes may be structured information. As an example, to input structured information the user may be presented with a form seeking particular information, such as medications they are currently taking or procedures they have had or will have. The fields within the form may be linked to other data entries in the platform health record system, such as reference materials for the entered medication or procedure. Moreover, the information need not be clinical in nature, as described in foregoing examples, but may be administrative in nature, such as benefits information.

A patient undergoing treatment for mood disorders may be asked to maintain an electronic ‘diary’ where he/she answers queries regarding his/her mood. In the alternative embodiment, data entered each day would be used to build the patient's profile database. At the end of a period of time, the platform would update the individual's profile. Alternatively, the electronic ‘diary’ may also be presented to the healthcare professional at a personal or telehealth visit.

The patient may have the ability to add one or more family members to the platform. The patient may grant these family members certain rights related to the information available to the patient on a platform. For example, the patient's may be able to delegate access to certain medical information to family members or caregivers. The patient may be able to remove family members or any information regarding those family members. The patient may provide contact information for the family members in case of an emergency. The access that the patient grants to family members may be granular in nature. For example, the patient may grant one family member access to transaction billing history, while another family member may have access to medical history and reports.

Through the platform, the patient may have an opportunity to donate towards one or more nonprofit organizations. Nonprofit organizations may distribute donated funds to other users of the platform if they are unable to pay for services from health professionals

In one embodiment, the patient may have access to previous financial transactions made through the platform. For example, the patient may be able to review payments towards medical professional, or specialists engaged by a medical professional over the platform. In cases where patients has medical insurance, and the medical insurer is integrated within the platform, the patients may see payments and offsets from the insurer as it relates to consultations and other medical services provided through the platform. The patient may elect to pay all or a portion of any balance due or may elect to pay ahead to develop an account credit toward an upcoming transaction. To permit the user to make a payment, the server may display a pay online option for the account.

In one embodiment, the patient may have the ability to send and receive electronic messages similar to email between the patient, medical professionals, and related staff. In some embodiments, the messages may be SMS messages sent and received through the patient's mobile phone. The platform may store these messages for review by the patients and medical professional at a later time. Messages may also be sent between patients on a platform. An online consultation platform that guides the patient through an interactive interview, builds a succinct message to the provider, and furnishes the provider with an array of tools to efficiently reply to the patient.

The medical professional may have a different view into the platform. For example the medical professional may have the opportunity to manage appointments with multiple patients, view and edit their profile, initiate or respond to communication between medical professionals and/or specialists, manage their schedules for live care and in-person appointments, review and manage transactions made to the platform, review their call history with patients, prescribe medications and review previously prescribed medications, and send or receive electronic messages through the platform.

Many of the features available to medical professionals are similar to features available to the patient. However, there are some notable differences. For example a medical professional will be able to view all of their appointments, including appointments made by multiple patients. Medical professionals may be permitted to enter their availability for appointments.

Medical professional will have an opportunity to consult directly with other medical professionals, either through video, text, and/or phone through the platform. The medical professional will also be able to view one or more of the transactions made through the platform based on the medical professionals work. The medical professional may be able to view transaction status, including reimbursement status from one or more insurance companies.

An electronic prescription service may facilitate writing and filling of new prescriptions and authorization of refills and renewals. Medical professionals, staff, and patients can instantly transmit authorized prescriptions to virtually any pharmacy in the United States chosen by the patient without resorting to “phoning in” the prescription, automatically screen for drug interactions, and ensure formulary compliance. The electronic prescription service advantageously includes the patient in the prescribing process, providing a capability wherein the patient makes the final decision whether or not to fill the prescription and directs the prescription to the pharmacy of his or her choice.

The platform may be configured to work with third-party developers and third-party health apps through one or more APIs. For example, the platform may be able to read weight and heart rate data from a consumer health tracking device. The platform may also integrate with other applications, such as dietary applications, exercise applications, etc. The platform may also interface with other personal health records and personal health apps.

Because the platform collects data for one or more cohorts of patients, the data may be anonymized and use for management, performance, and analytics. The platform may be modular, for example, one or more organizations may have access to a plurality of patients. In this way, the organization can track their patients' usage of the platform, transactions made to the platform, and insurance reimbursement. In another example, the platform may allow medical professionals to broadcast patient education materials, patient newsletters, and preventive and self-care information that can be customized and automatically distributed to targeted patient groups.

In one embodiment, the platform may provide a single sign-on mechanism that allows users to access the system from other applications. For example, the platform operator may establish a business relationship with a large group practice or an HMO. The business partner may prefer that their providers and their patients sign-on to the system from their web site, rather than requiring users to navigate to the system web page before signing on. The single sign-on allows the business partner to handle the authentication layer through their web site or app.

A partner wanting to use the single sign-on feature may first establish a licensing agreement. Once the licensing agreement is established, the partner receives a license key and password necessary to access the system. The single sign-on allows the partners to automate access to all authorized applications through a single login, eliminating the need to remember multiple sign on processes, user ID's and passwords, and providing seamless integration and uninterrupted user experience between internal partner systems and network applications provided by the invention.

The user, either patient or provider (or third party), who is currently logged in and authenticated on the business partner's application requests access to the system by clicking on a link or button in the partner's application. A request is made from the partner's server to the single sign-on service with the partner's credentials, and the user who is requesting access to the application. The server validates the partner's credentials and generates a unique link that the partner may use to perform a single sign-on for the particular user. The link may only be valid for a limited time period, ten minutes, for example, or even less. The partner's application redirects the user's application to the link that was returned from the single sign-on web service;

According to another embodiment, the platform may be implemented across a multi-site medical network configured with a communications platform for transmitting and receiving data, audio and visual images at multiple locations perceptually simultaneously (e.g., in real-time) using high-speed networks and video conferencing capabilities (e.g., audio and visual interfaces and monitors) at each location site. The multi-site medical network is a macro solution to healthcare access and may be provided on a city, state or country-wide basis, and may be accessible anywhere a sufficient bandwidth connection is available. Where an insurance company supports the telehealth communications network, a patient/insured may thus be provided with access to covered healthcare virtually anywhere, and the patient's geographic location relative to the insurance company's network area does not constrain access to healthcare.

Systems and methods of the present disclosure may provide a single mobile platform to coordinate all key clinical care communication. The platform may provide a simple and easy approach to scheduling, EMR integration, secure texting, three-way tele-consultation, as well as patient care. The platform may allow additional functional layers on top of any EMR or data-analytic application for population health management. By providing mobile as well as desktop access to care, patients are not forced to take time off to see a physician. In addition, the platform may allow for automated or semi-automated discharge planning In one embodiment a follow-up tool is used to prevent readmissions within 30 days. For example the discharge planning follow-up tool may send reminders to the patient and their health care professional about follow-up treatment, home therapy, and other readmission prevention techniques.

Systems and methods of the present disclosure may be integrated into medical devices, such as infusion pumps, health trackers, and other medical tools used outside of medical professionals direct supervision.

In one embodiment, the platform can be linked to secure chat systems, such as mychat, or other EMRs via APIs. The APIs may be public or private. The platform may also include a real-time provider tracker with GPS enable patient linkage. In this way a patient can see where their medical professional is located at any given time. This may be especially useful for medical professionals that hold office hours in a variety of locations during a variety of times. The platform may also include secure text messaging with the patient for care coordinators. For example care coordinator may be able to send secure text messages to the patient after their visit (either in person or through the platform) in order to follow up with the patient regarding their medical care or administrative questions.

The platform may also be used for care coordination for population health. For example by aggregating data collected by the platform, medical professionals can track community health issues and prepare educational content to address those issues. In another example, the platform may send automated messages or information to patients that fall within a certain cohort. In this way, seniors may be sent information related to healthy exercise for their age, osteoporosis, and other medical issues affecting the elderly.

Some embodiments of the disclosed platform may include a medication reminder system. The medication reminder system could alert patients about when they should be taking prescribed medicine. The platform may configure these alerts based on the prescriptions entered by the medical professional into the platform. The alerts may be sent to the patient via secure text message, or in the case of a mobile phone, through an alarm set on that mobile phone. Other types of alerts may be sent, including an automated telephone call. The medication reminder system may track whether or not a patient is compliant with the medication schedule. In instances where the patient is not compliant, the platform may indicate to the medical professional that a follow-up is needed.

Some embodiments of the disclosed platform may include social integration. For example, patients may choose to share some or all of their access to the platform with other users. This may be especially advantageous for family members that wish to share medical responsibilities. The social integration may also be used to encourage accountability. For example the platform may notify friends and family if the patient fails to comply with the medication schedule. With social integration, a patient that has been diagnosed with a particular disease may be encouraged to join a group, such as a support group for users with the same disease. For example the patient is diagnosed with diabetes, the social integration component would allow them to connect with other patients of a similar age, gender, health background to discuss treatment options and lifestyle questions.

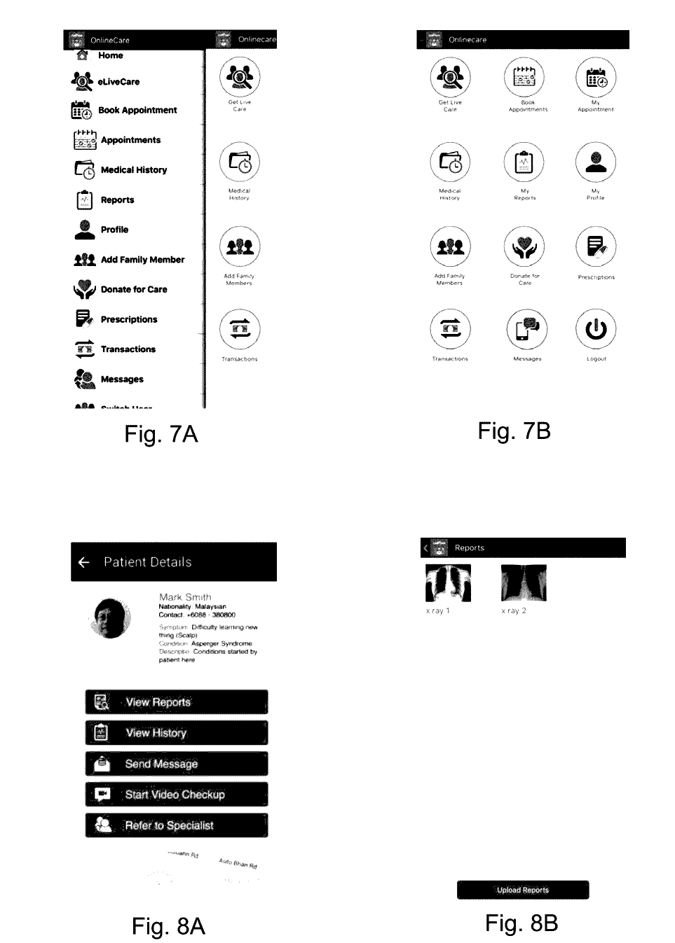

FIG. 7A shows one embodiment of the graphical user interface for a mobile device to access the platform. On the left of the image is a list of platform services that the user can access. For example, the user (in this case a patient) can access live care (such as a telemedicine consultation), book appointments (either appointments for a telemedicine consultations or in person appointments), view already scheduled appointments, view their medical history, view their reports, view and edit their profile, and family members either for their access to the patient's medical information or to help organize medical information related to hereditary conditions, donate to the platform for medical care to those in need, view their prescriptions, view their transactions, and send secure messages between patients and medical professionals.

FIG. 7B shows the same embodiment of the graphical user interface in FIG. 7A. Many of the same features of the platform can be accessed through the screen through various icons displayed on the screen.

FIG. 8A shows one exemplary embodiment of a patient details screen. The patient details screen may contain a photograph of the patient. The photograph may be provided by the patient, for example using the mobile devices onboard camera, or the image may be provided by a health professional during an in-person visit. The patient details may also include the patient's name, their nationality, their contact information, and pertinent medical information. For example, the patient details may include a listing of symptoms that they have recently complained about. The patient details may also list existing diagnosed conditions and a description of those conditions. The user may have the option to view reports on the patient, view the patient's history, send them a secure message, start a telemedicine consultation, or refer them to a specialist. In this case, FIG. 8A represents a screen that would be viewed by a medical professional. The screen may appear differently if viewed by a specialist or by the patient. The screen may include geographic information, for example a map that shows the current location of the patient.

FIG. 8B shows one exemplary embodiment of a report screen. For example the report screen may contain medical images, such as x-ray images, that have been taken of a patient. Both the patient and the medical professional may have the opportunity to upload new reports. The reports may include test results, medical imaging, medical diaries, medical transcriptions, and other pertinent medical information. The medical professional in patient may be able to select one or more reports on the screen. For example a report may be selected to view a medical diagnostic imaging greater detail. Different users may have different access to these reports. For example the patient may have read only access to the reports, whereas a medical professional may have the ability to add, remove, and edit the reports.

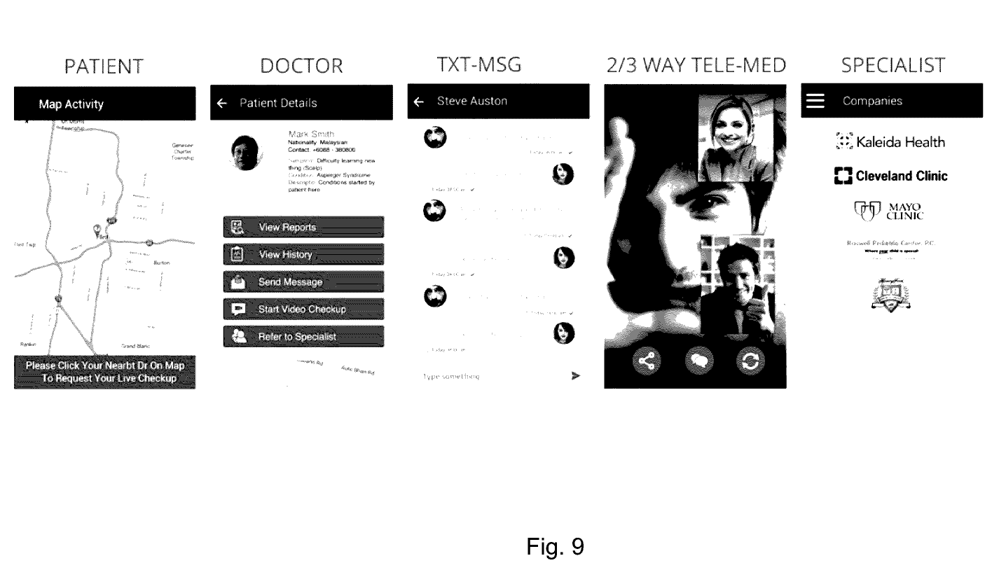

FIG. 9 is a graphical representation showing multiple features of the platform. For example the platform may include features geared towards patients, doctors, secure text messaging, two or three way telemedicine, and specialists. The patient can use the platform to manage their medical questions, comments, and concerns. A doctor on the platform may be able to view that patients details, including any presently occurring symptoms. In some cases the doctor and patient may find it sufficient to simply correspond over secure text messaging. As used herein, secure text messaging may refer to encrypted communication between the parties, and/or storage and transmission of the communications on a secured server. In some embodiments, a secure text message may exist solely on a single server which is accessed by the medical professional and the patient. In this way the secure text message may comply with HIPAA and other medical and privacy regulations. The platform may also allow for two or three way telemedicine features, such as video or audio conferences between the patient, a medical professional, and specialist. The platform may include a listing of specialists in certain areas that the medical professional may contact.

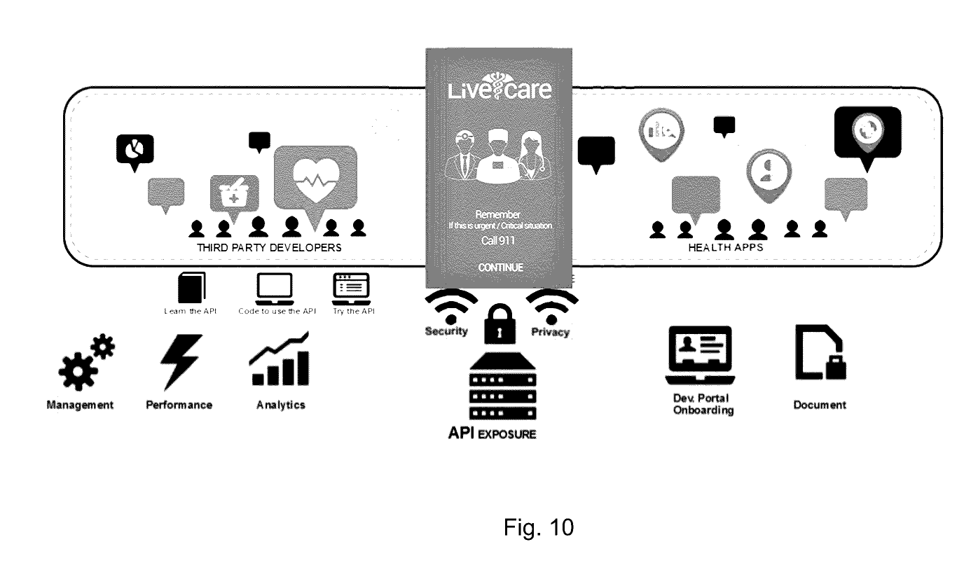

FIG. 10 illustrates a high-level diagram showing one embodiment of the medical care platform. The platform may be centered around software application accessible both on a mobile device and desktop computer. The application may have access to a secure and private server that contains patients and medical information. All transactions through the platform may occur through that server. Third-party developers may communicate with the application and server, for example to provide medical tracking information, nutrition and health information, prescription and pharmacy information, vital information (including heart rate, exercise, location, and other pertinent medical factors). The third-party developers may communicate with the application server through APIs. Other health applications may also communicate with the platform. For example health applications such as electronic medical records, personal health records, communication applications, financial and insurance applications, and other medical related applications can integrate with the information stored in the presently disclosed platform. The platform may allow for granular management. For example insurance companies, HMOs, and other health organizations may manage their patients and medical professionals using the platform. In another embodiment, the platform may provide analytics to the patient, health care professional, and their administrators. For example administrators may be able to view a patient's usage of the platform, a medical professional's usage of the platform, and related follow-up statistics.

In one embodiment, the platform may include an on boarding portal for developers, for new patients, and for the medical professionals. The platform may also include systems and methods for secure medical document storage.

Certain embodiments disclosed herein provide for systems and methods for enabling telemedicine consultations. For example, one method disclosed herein allows for a patient to identify a desired physician through a database search and immediately establish a rich multimedia consultation session with the physician if the physician is available. Another method disclosed herein allows for a patient to enter a virtual waiting room where available physicians can establish a rich multimedia consultation session with the patient on demand In yet another method disclosed herein, the physician can consult with a specialist after establishing the rich multimedia consultation session, such as by including the specialist into the consultation session.

The rich multimedia consultation session may allow the physician to diagnose the patient and prescribe a treatment protocol, which can be communicated to the patient during the rich multimedia session and also after the session, for example by delivery of a prescription by facsimile or other electronic means. After reading this description it will become apparent to one skilled in the art how to implement the disclosure in various alternative embodiments and alternative applications. However, although various embodiments of the present disclosure will be described herein, it is understood that these embodiments are presented by way of example only, and not limitation.

Technology allows for the transmittance of real time audio-video data via a communication device that has a digital camera and a microphone. For example, a standard smartphone, such as the iPhone®, is capable of HD video with audio and features a still camera with an LED flash that produces quality photos and video.

Based on this technology, images and video captured by the communication device are sufficiently reliable to replace the need for an in-person encounter with a medical provider for certain issues. However, most telemedicine solutions start at around $30,000 for the equipment on both ends. The present system greatly reduces costs by allowing patients to use consumer grade communication devices as the telemedicine equipment. Advantageously, many consumers already own such equipment in the form of smartphones or computers with webcams.

The Internet is a common vehicle for private and confidential, secure transactions dealing with health information or financial information. In cases in which two parties of a conversation are unable to physically be in the same location, both individuals and organizations have become comfortable and familiar with utilizing videoconferencing via the Internet to simulate face to face interactions. Videoconferencing, as described herein is a set of interactive telecommunication technologies which allow two or more locations to interact via two-way video and audio transmission simultaneously.

The present system for enabling telemedicine consults provides a technical solution for a convenient and rapid ability to locate a qualified on-call medical provider through custom search and engagement in a confidential face to face patient consultation from anywhere in the world where a data communication network exists. The system provides a technical solution for the ability to evaluate, treat, transmit results, and manage the referral process. The system can be applied to all areas of medicine, where a doctor uses real-time audio and video conferencing with patient history for diagnostics including, but not limited to: internal medicine, family practice, pediatrics, dermatology, pathology, radiology, trauma, ophthalmology, ear, nose, and throat diseases, etc. The system allows a physician status module to locate an on-call medical provider that matches the patient's needs. The physician is readily available for live confidential patient consultations using a communication device with real-time audio and video technologies to facilitate evaluation, diagnosis, and treatment.

In one embodiment, the patient has a unique personal identifier, such as a number. The identifier may be unique to each patient encounter for privacy and confidentiality purposes. The patient may receive first-hand medical information related to the on-call care. The patient may receive first-hand medical information related to the order, recommendation, or treatment plan to follow on-call care. The medical information includes a possible diagnosis, treatment recommendations, and recommendations for follow up. The patient has ongoing access to the results and the referred to party/entity receives specific instructions.

In one embodiment, the patient who requires medical attention launches the application. The patient enters symptom criterion (e.g., based on perceived symptoms). The criterion may be used to limit the list of qualified medical providers that are eligible to field a call. The selection process may comprise of a method to match profile criteria to query criteria. The patient may be presented with a series of questions to help produce a list of qualified medical providers to address the unique medical need. In one embodiment, the patient is placed in a virtual waiting room where available physicians can review the waiting patients and their criteria before engaging in a call. In another embodiment, the patient may select from the list of available physicians which includes the option to visit a medical provider in person or via video conference with a physician on-call who is immediately available to see the patient. There may be signals to indicate the wait time and there are controls that limit waiting time by minimum and maximum periods. The patient can choose to wait a minimum period, a maximum period, return at a later time, schedule a time with a preferred physician, or redirect to another qualified physician on-call.

In one embodiment, the patient may provide a zip code to the application. The zip code may be used as a query criteria to match a patient with a physician, or urgent care center. For example, the patient may enter 90210 as a zip code. The application may send this zip code to the server as part of a query. The server may return information to the patient, such as urgent care centers and emergency departments within 5, 10, 15, or 20 miles of the provided zip code. The zip code may also be used to match the patient with physicians that are located nearby.

The patient may complete several forms, disclose medical history and provide consent prior to medical evaluation. The patient may provide contact information and payment information to request consultation. The patient may also provide payment information and insurance information to urgent care centers and emergency departments through the application. The physician may launch the secure application on her communication device to engage patient consultation. The patient and the physician conduct a confidential telemedicine consultation. There may be a process to validate patient information and further agreements based on the consultation.

In one embodiment, the application allows for the visit to be completely recorded and documented. The resulting recording and medical information can be securely stored and all or portions of it are transmitted to the on-call physician, her office, the patient's insurance company or any number of alternative or additional destinations and all or portions of the resulting recording and medical information can also be stored in the form of electronic health data, EOB, medical notes, orders, prescriptions, and other storage formats critical for seamless Health Information Exchange (“HIE”) amongst varying providers.

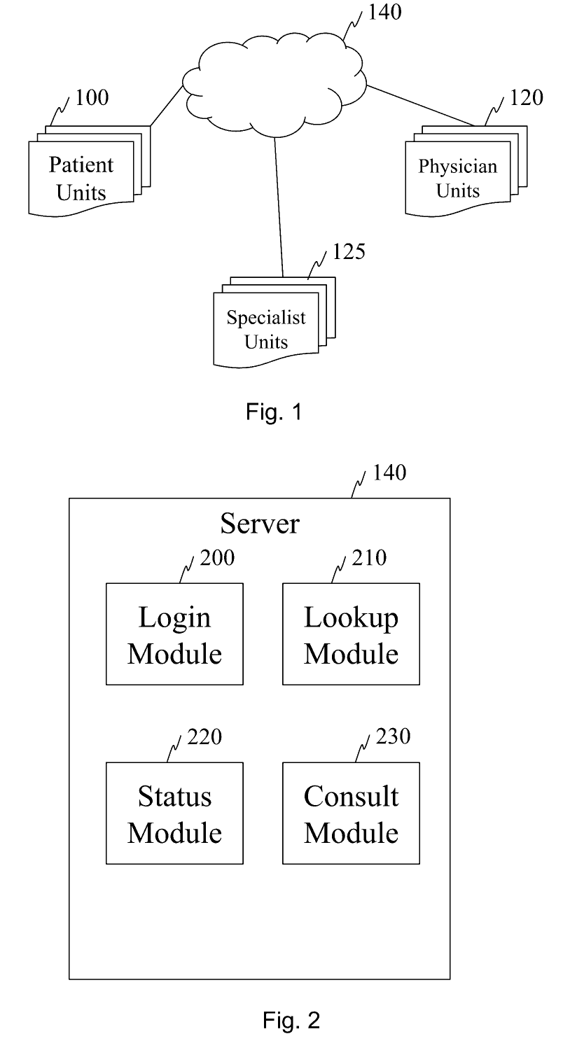

FIG. 1 is a network diagram illustrating an example system for enabling telemedicine consults according to an embodiment of the disclosure. In the illustrated embodiment, the system comprises one or more patient units 100, one or more physician devices 120, one or more specialist units 125, and one or more servers 140. These network devices are communicatively coupled via a communication network. Each of the network devices are also configured with a data storage means.

The patient unit 100, physician unit 120, and specialist unit 125 can be any sort of processor enabled communication device that is capable of communicating over a network with other devices. For example, the communication devices can be in the form of a personal computer, laptop, personal digital assistant, tablet computer, smartphone, music player, or any other such device that is capable of establishing a rich multimedia session with another communication device over the network. The server 140 can also be any sort of processor enabled communication device that is capable of communicating over the network with other devices. The server, however, does not necessarily need to be able to participate in a rich multimedia session with another communication device.

FIG. 2 is a diagram illustrating various server modules. The server 140 may comprise a login module 200, a lookup module 210, a physician status module 220 and a server consult module 230.

The login module 200 may be configured to validate patients, physicians, and specialists that login to the server 140. In one embodiment, patients and physicians each login to the server 140 prior to being able to establish a rich multimedia session for a telemedicine consult. The login module 200 is also configured to register new patients, physicians, and specialists and establish accounts for these users of the server 140. In one embodiment, the login module 200 collects necessary medical background information, insurance information, and payment information from a new patient as part of registering the new patient and creating an account for the new patient on the server 140. Additionally, the login module 200 may also collect necessary information from a physician or specialist prior to validating and approving the physician or specialist for inclusion in the database of physicians or specialists.

The lookup module 210 is configured to manage and maintain a database of physicians, patients, and specialists stored in an accessible data storage area. The data storage area could be in the patient, physician, and specialist units or in the server 140. Data storage area can be local or remote to the server 140, but is preferably local. The database of physicians, patients, and specialists comprises a vast amount of information about individual physicians, specialists, and patients, including, but not limited to practice groups including specialties and locations. Additional information including feedback and other social media commentary may also be included. The lookup module 210 is also configured to allow patients to search for and evaluate potential physicians the patient may desire to consult with. The lookup module 210 also interfaces with a list of physician and specialist schedules. The lookup module 210 might query the database to see what physicians and specialists are available. If the lookup module 210 is used by a physician or specialist, the lookup module 210 may provide a list of waiting patients. The lookup module 210 may return availability by specialty and time to assure the patient will not wait longer than a predetermined period of time before a consultation begins. This may be particularly important in embodiments where the patient may select the physician or specialist.

The lookup module 210 also tracks what doctors, patients, and specialists are available and logged in so that the patient, doctor, or specialist can continue to hold, choose an alternative patient, physician, or specialist. Accordingly, a patient, physician, or specialist may browse through physician, patient, or specialist profile information and social media commentary information about a plurality of physicians, patients, and specialists in order to identify one or more desired physicians, patients, or specialists to consult with.

The status module 220 is configured to maintain a current status for the physicians, patients, and specialists in the database. In one embodiment the status may be “available” or “unavailable.” Other statuses may include, “waiting” (to indicate that a patient is waiting in the waiting room) or “in consultation” (to indicate that a patient, physician, or specialist is currently in a consultation). In this way, a patient, physician, or specialist browsing through the database knows if the users are presently available for a telemedicine consult. In alternative embodiments, additional status indicators may be included, for example, a physician may be taking on new regular patients or may be available in two hours or two days or the physician status may include a calendar that includes certain days and times during which the physician will be available for a telemedicine consult. Advantageously, a patient may be able to schedule a telemedicine consult with a desired physician in this manner

The consult module 230 is configured to establish a telemedicine consult session between the patient unit 120 and the physician unit 130. If needed, the consult module 230 can establish a telemedicine consult session between the patient unit 120, the physician unit 130, and the specialist unit 125. In one embodiment, the consult module 230 works cooperatively with a patient, physician, or specialist consult module resident on the patient, physician, or specialist unit, respectively. The telemedicine consult session is preferably a real time audio and video conference session but any rich multimedia session that allows the physician to receive sufficient information (e.g., text, audio, video) to evaluate a patient to make a diagnosis may comprise a telemedicine consult session. In one embodiment, the consult module 230 establishes the rich multimedia session in a fashion that screens the personal contact information of the patient, the physician, and the specialist (if applicable) from the other party to the rich multimedia session. This screening advantageously allows patients and physicians to use their existing personal communication devices for the rich multimedia session without providing the personal contact information to the other party. This is particularly helpful for physicians who do not wish to be contacted by a patient on their personal communication devices outside the context of a dynamically arranged or scheduled telemedicine consult.

The consult module 230 may also be configured to record the rich multimedia session and store the session in a data storage area. The consult module 230 may also be configured to send all or portions of the rich multimedia session (e.g., just the pertinent information) to the patient, the patient's primary physician, an insurance company, an electronic health record management system, pharmacy, or other designated recipient. The consult module 230 may also be configured to deliver prescriptions from the physician to the patient. For example, the physician may write a prescription, scan the prescription and upload the prescription to the server 140 and the consult module 230 delivers the prescription to the patient. In one embodiment, prescriptions may be delivered via email, facsimile, or any other digital, electronic, or physical means.

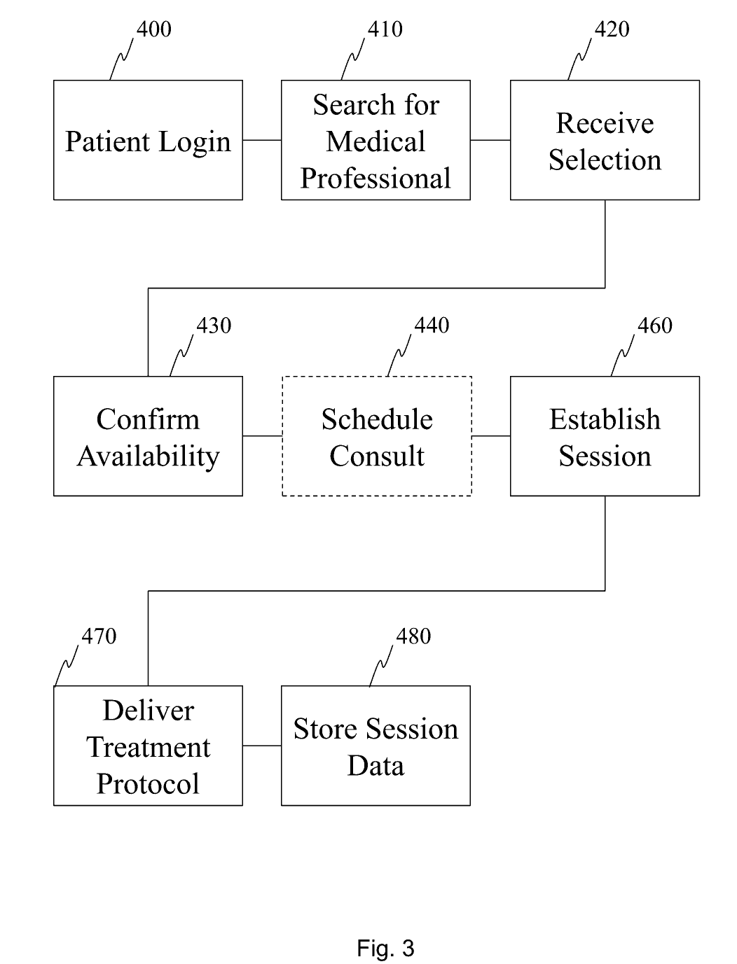

FIG. 3 is a flow diagram illustrating an example process for enabling a telemedicine consult according to an embodiment of the disclosure. In one embodiment, the process may be carried out by the system previously described with respect to FIG. 1. Initially, in step 400 the patient login is validated. If the patient is a new patient, then a patient registration process is carried out after which the patient login is validated. Next, in step 410 the consult server facilitates a waiting room for the patient. The patient may request a physician or specialist by a variety of criteria and the patient may also establish and store certain criteria in the patient's profile that are automatically used by the search system to filter the results. For example, the patient may only want a female doctor and this criterion can be stored in the patient profile (along with other criteria) so that all searches automatically include this criterion or so that all search results are automatically filtered by this criterion. Once the patient has conducted the search in step 410, the consult server receives a patient selection from an available physician in step 420. Next, in step 430 the consult server determines the current availability of the physician and patient for a telemedicine consultation.

In one embodiment, the waiting room may estimate availability of the next physician. For example, it may also include general availability such as accepting new patients or available to schedule a telemedicine consultation at some future time. A calendar of available future times may also be accessible to the patient to view and schedule a future telemedicine session. Accordingly, in optional step 440 a future consultation may be scheduled.

If the patient and physician are currently available for a telemedicine consultation, in step 460 a rich multimedia session is established between the communication device of the patient and the communication device of the physician. The rich multimedia session may be a video conference call or it may be a voice call enhanced by still images transmitted from the patient to the doctor as needed.

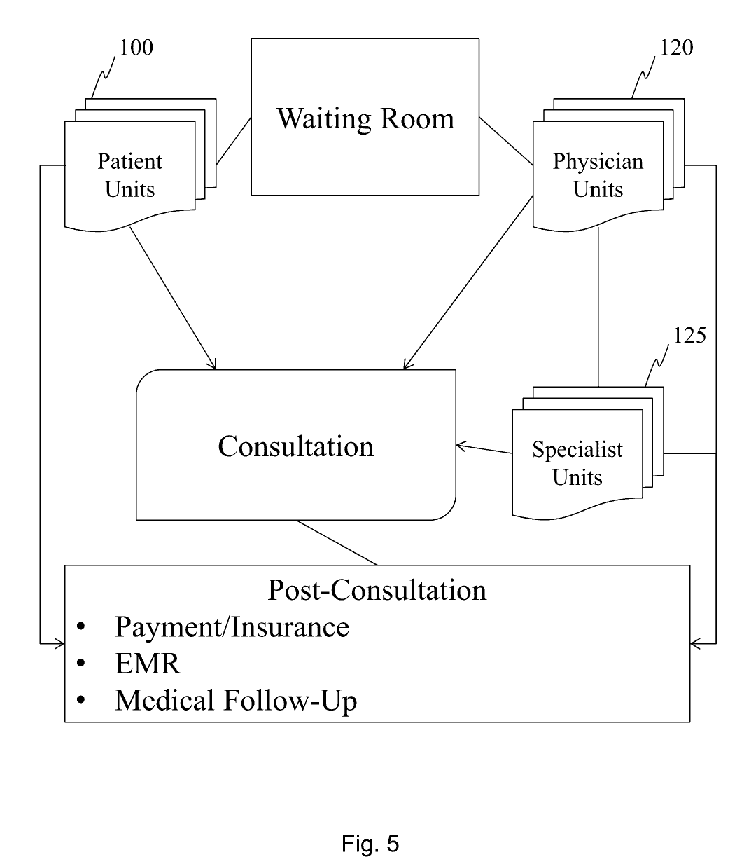

At any time during the telemedicine consultation, the physician may request a specialist to join the consultation. The specialist may be joined in a similar manner as the patient and physician. The server instructs the patient unit, physician unit, and specialist unit to communicate together as a three-way consultation (e.g., the patient, physician, and specialist can all communicate with each other simultaneously over audio and/or video). The three-way consultation, and any other consultation described herein can be performed cross-platform and cross-OS. For example, the three-way consultation can be performed using an Android® mobile phone patient unit, be an Apple® iPad® physician unit, and the a Windows® desktop computer specialist unit. FIG. 5 illustrates one example of a three-way consultation and post-consultation.

At the end of the telemedicine consultation, in step 470 the consult server facilitates delivery to the patient of any treatment protocol including any prescriptions provided by the physician. Delivery may be made by electronic means or facsimile or any other means. Finally, in step 480 the consult sever stores a portion of or all of the data from the telemedicine consultation session.

In one embodiment, the stored data may include an entire transcript of the rich media session and any treatment protocol and prescriptions provided by the physician or specialist. The recorded session/stored data may also include demographic information about the patient, the physician, or the specialist, for example, information obtained the patient, physician, or specialist user profile that is stored on the consult server. In this fashion, a complete record of the telemedicine session can be maintained for the benefit of the patient and the physician. Advantageously, all or portions of the stored record of the telemedicine consultation session may be provided by the consult sever, for example to an electronic health record storage facility, a primary care physician for the patient, an insurance company, or any other entity designated by the patient or physician.

In an exemplary embodiment, the patient is directed toward registration/login on the consult server and asked for their username/password. If the patient is a first time user, the patient fills out the patient registration form before continuing. After successfully logging in, the patient enters a medical complaint and is queued in a virtual waiting room. Physicians registered with the server can view a list of patients in the virtual waiting room, including their registration information and stated medical complaint. Once a physician chooses a patient, a real time telemedicine consult is established between the patient unit and the physician unit.

When the physician is searching for a patient, the physician is notified that this patient is either online or offline (available or unavailable). If the patient is offline, the physician returns to the patient search to try again. Once the physician chooses an online patient, the online patient can accept the request. Alternatively, the patient can also deny the request. In one embodiment, the consult server may set the status of a physician to “offline” if the physician has too many patients already queued up for a live telemedicine consultation. If the patient denies the request, the patient returns to the waiting room. Advantageously, a message is displayed and/or played through a speaker to the patient informing the patient that if the patient believes they have a live threatening condition contact 911 or seem immediate emergency assistance.

At any time during the consultation, the physician may determine that a specialist is required. The physician may request a specialist through the server. The physician may be able to send the specialist patient information and other medical information based on the ongoing consult. The patient, specialist, and physician may then be joined together in a single telehealth consultation.

At the end of the consult, the patient may be prompted to rate his or her experience, satisfaction and recommendation. The patient rating may be accomplished via a text message or other post consultation paper or digital process.

Described herein is an approach to the doctor/patient/specialist relationship that incorporates selection and filtering processes which accommodate criteria in order to find an appropriate doctor, patient, or specialist and schedule a consultation.

In one embodiment, a system is provided for a physician referral network which receives incoming patients and physician profile information and uses this information to quickly find an appropriate specialist for a specialized, interactive virtual consultation. Referrals of specialists to doctors may originate from many sources, such as fellow doctors, healthcare providers, employers and patients themselves. Referral networks may be established that limit which specialists may be available. For example, a patient in a preferred provider organization (PPO) may see different doctors and specialists than another patient in a different PPO. In another example, if a doctor is going to refer a patient to a specialist through the system, the doctor's selections may be limited to specialists within the patient's PPO. In embodiments utilizing this network referral management system, additional data may be associated with each patient, physicians, and specialist to identify their membership in one or more PPOs. The system may query and filter patients, physicians, and specialists based on pre-determined PPO rules.

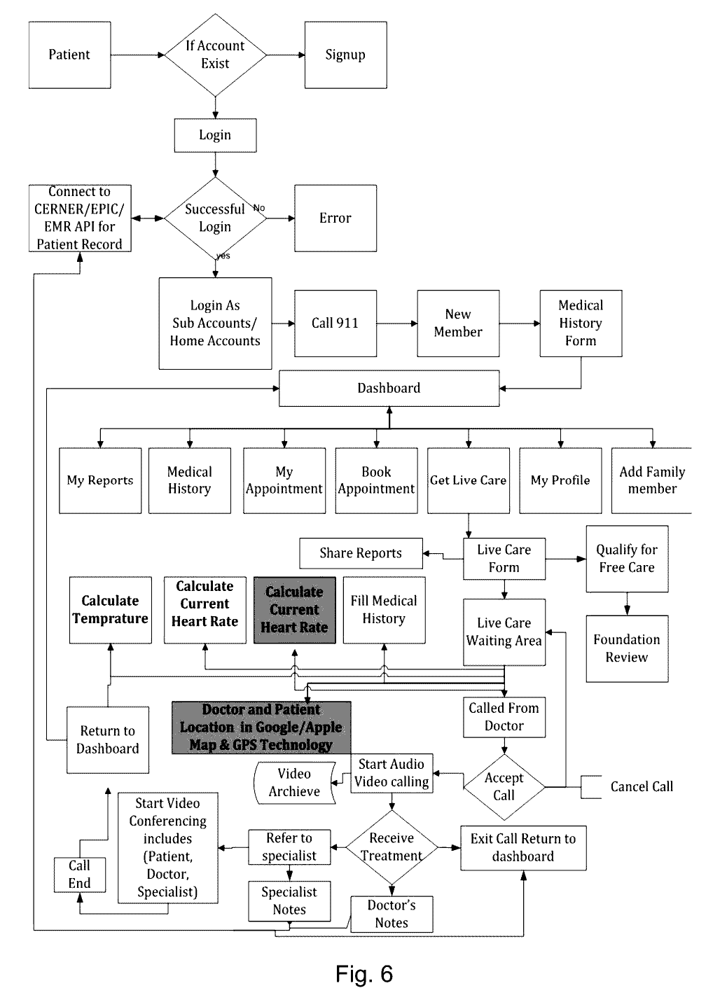

FIG. 6 is a flowchart illustrating a telemedicine consultation between three parties according to an embodiment of the disclosure. A patient accesses the system. If the patient does not have an account, the patient is required to sign up for an account. If the patient has an account, the patient is asked to log in to the system. If the login was successful, the patient can access their accounts. The patient is given the opportunity to call an emergency number, such as 911 if their condition is critical. If the patient is a new member, they are asked to fill out a medical history form. This form is accessible on a patient dashboard. The patient can access a variety of information through this dashboard including their reports, their medical history, their appointments, their profile, and their family members. Patients can book appointments or get live care from the dashboard.

If the patient requests live care, they are prompted to fill out a report on their current symptoms and reasons for requesting live care. These reports are shared with physicians and specialists. In additional, the report may be shared with an EHR or the patient's insurance provider.

The patient then enters a live care waiting area. While the patient waits, they can update and improve their medical history, collect medical information from the patient's unit, such as blood pressure, heart rate, temperature, etc., and search for local physicians based on the patient's declared location or a location gleaned from the patient's unit.

While in the waiting area, the patient may receive a call from a nearby (or simply available) physician. The patient has the option to accept or cancel the call. If the call is cancelled, the patient returns to the waiting room. If the call is accepted, the rich multimedia session is established between the patient and the physician. The multimedia session may be recorded and archived.

During the call, the patient will receive treatment from the physician. If the treatment is sufficient, the call may end and the patient will return to the dashboard. The physician has the option to refer the patient to a specialist through the system. In this case, the specialist will join the rich multimedia session and a three-way conversation can begin.

Some embodiments of the present disclosure enable a simple to use personal health record for scheduling, diagnosing, and prescribing. The data collected and shared during a consultation may be integrated with a medical carrier, external EMRs, ASOs, and ACOs.

By providing telemedicine remotely using embodiments of the present disclosure, employees are not forced to take time off to see a physician. As such, the average time of missed work to see a family practice physician decreases. This helps reduce financial impact to the employer. For those employees treating sick family members, telemedicine has been proven to enhance the quality of care with a faster response time.

In addition, the present disclosure will help redirect ER and urgent care utilization to more appropriate modes of care.

One embodiment of the present disclosure may incorporate a donation module. If the patient is unable to pay for the consultation, or meets certain criteria, the payment request can be sent to a third-party foundation. This may be done through a hyperlink in the application, or through an API. The third-party foundation may pay for some or all of the consultation cost. The consultation costs can be paid directly and seamlessly by the foundation, the patient, or a combination thereof.

In another exemplary embodiment, there may be four different users (i.e., Patient, Doctor, Specialist, and Admin). Each user may be presented with a different graphical user interface or different content in the graphical user interface. Each user may have their own profile roles. Patients can search for doctors by zip code and make online appointments. Patients can also edit and view their own profile, reports, and medical record and make optional uploads from medical devices. Doctors can approve appointments, gives e-prescriptions, and view patient health records. Doctors can also consult to other specialists. An admin has the authority to add or delete users as well as grant permissions for different controls to different types users. A specialist may only consult with patient if doctor refers.

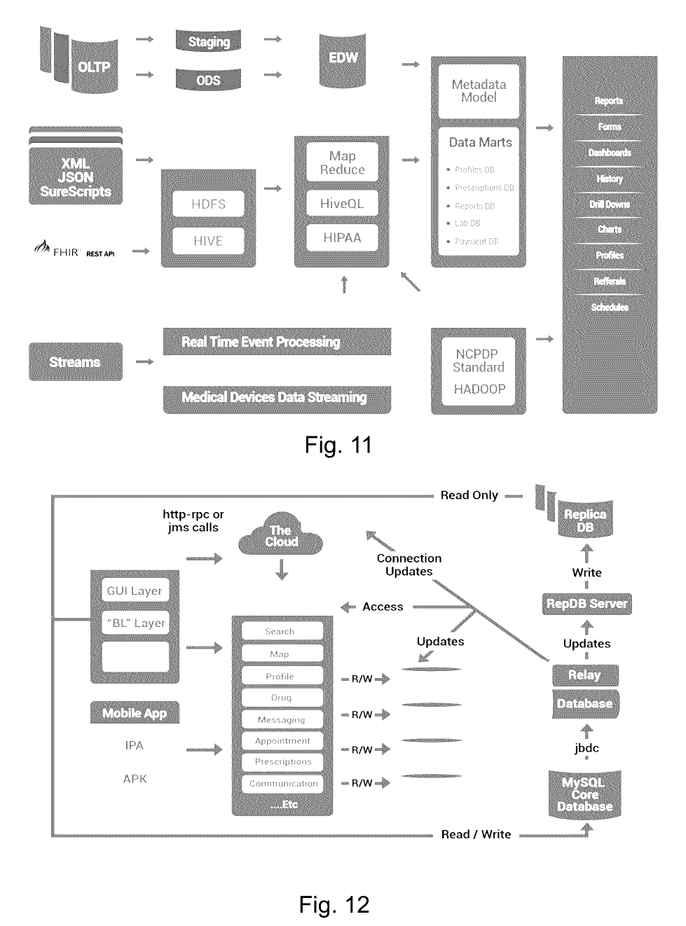

FIG. 11 is a flowchart illustrating a technical design for one or more embodiments of the present disclosure. The design may utilize a data modeling approach called online transaction processing (OLTP). One or more OLTP databases may be provided. The OLTP database may store live operational information.

Information in the OLTP databases may be cleansed (i.e., automatically reviewed and modified) and merged (i.e., merged with existing known data) before storing the data through the process of staging. In parallel, an operation data store (ODS) may check useful data against predetermined business rules to ensure data integrity. The ODS integrates data from various sources and structures into a single data structure for use in the system.

The enterprise data warehouse (EDW) may comprise one or more servers configured to store the data after the ODS and staging processes. The EDW allows valuable information to be accurate, well-organized, timely and consistent. In some embodiments, a business intelligence (BI) subsystem may be provided. The BI subsystem allows for the creation and use of metadata models and a variety of other business intelligence features, known as data marts, such as databases for profiles, prescriptions, reports, labs, and payments. One exemplary feature of a metadata model may be defining vital characteristics of assets in a way that is unique to a specific organization. The metadata models may describe a series of key entities or classifications. Stand-alone data marts may be combined with other data marts to serve as building blocks for the EDW.

E-prescription transactions may be performed through XML to a dedicated prescription network, such as the SureScript Network. In some embodiments, for data delivery between servers and browsers, JSON may be used. JSON is computationally lightweight and may be preferable for data delivery. The dedicated prescription network may communicate using these modalities to a big data storage device.

In some embodiments, a Fast Healthcare Interoperability Resources (FHIR) Rest API may be used. The FHIR RestAPI may be used to integrate various medical devices into the system. The FHIR Rest API may communicate directly with a big data storage device, such one or more Hadoop clusters. The clusters may utilize a Hadoop distributed file system (HDFS) to store very large data sets consistently, and to stream those data sets at high bandwidth to the system. Apache Hive may be built on the top of the Hadoop clusters to provide data summarization, query and analysis.

In some embodiments, the data pulled from the big data storage may be processed, for example, using a Map Reduce Framework. The Map Reduce Framework is useful for machine learning. In some embodiments HiveQL may be used to improve development productivity when working with challenging data formats or complex analytical tasks. In addition, HIPAA security rules may be enforced during processing to secure critical patient information.

The presently disclosed system may utilize real-time or near real-time tracking of patients, doctors, and specialists. This allows for tracking of a specific-user on a graphical user interface map overlay.

FIG. 12 illustrates one embodiment of a data-flow diagram illustrating the flow of data within the presently disclosed system. The presently disclosed system may utilize cloud-based services to increase flexibility and security. The user-facing application (such as a web-based application) may have multiple layers, such as a GUI layer and a business layer. The GUI layer may be used for user interaction while the business layer realizes the pre-determined business logic for the system. A session cache may be used in the web-based application. A session cache is a data caching service used to store each user's session data. For increased redundancy, the session cache may provide a replica of a session stored in the cache. Therefore, in condition of power-cut, the system will maintain access to the session in the cache. In some embodiments, cloud-based graph databases may be used. Cloud-based graph databases allow the system to scale in real-time or near real-time. To increase redundancy and improve fault-tolerant some embodiments may use Replica DB.

Some embodiments of the presently disclosed system may utilize one or more application servers. An application server may be a software framework that facilitates the creation of web applications and a server from which the web applications are provided to end users. An application server may use, for example, PHP to build and deploy web applications. In other embodiments, a mobile application server may be used. A mobile application server may be mobile middleware that makes back-end systems available to mobile applications to support mobile application development. A mobile application server may bridge the gap from existing infrastructure to mobile devices. A mobile application server may provide data routing services, such as packaging data into smaller objects according to predetermined business logic that minimizes demands on bandwidth and battery. The mobile application server may also provide secure connectivity to backend systems managed by the mobile middleware. In some embodiments, the mobile application server may allow users to access data even though device is not connected.

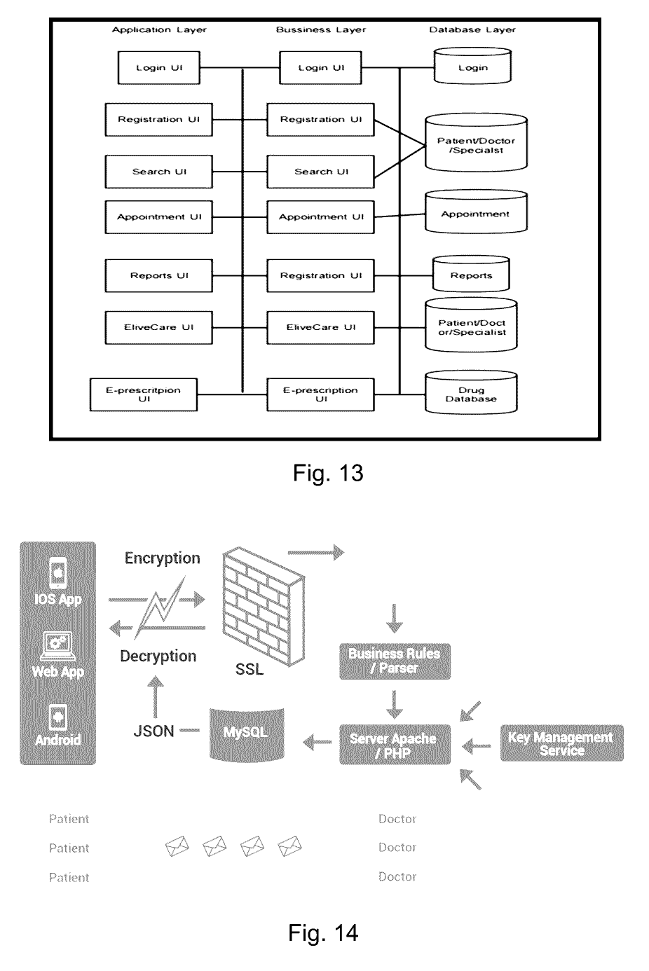

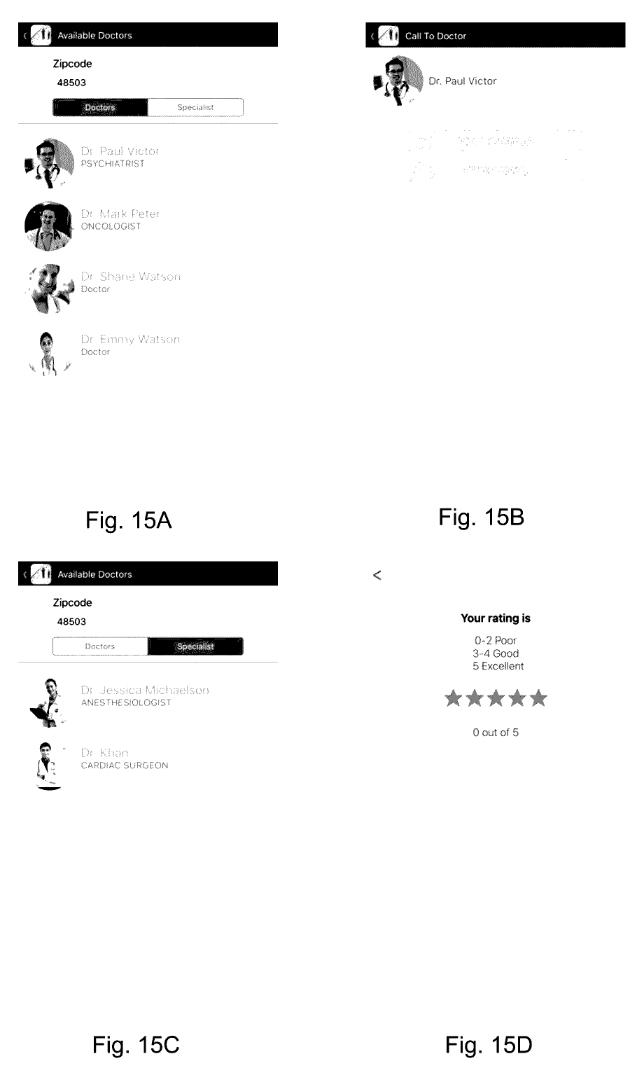

FIG. 13 illustrates the various layers (application, business, and database) that may be utilized in the system. The Online Application Layer comprises a number services, including FTP, Messaging, and various file and data transfer services. The Business Layer may comprise content management and authorization services. The database layer may be an interface which joins the communication between a computer application and databases such as SQL Server, MySQL, and SQLite.

Within the system, sensitive data may be transmitted using secured protocols. FIG. 14 illustrates security features that may be implemented in the presently disclosed system. One such secure protocol is HTTPS. Patient data may be encrypted.

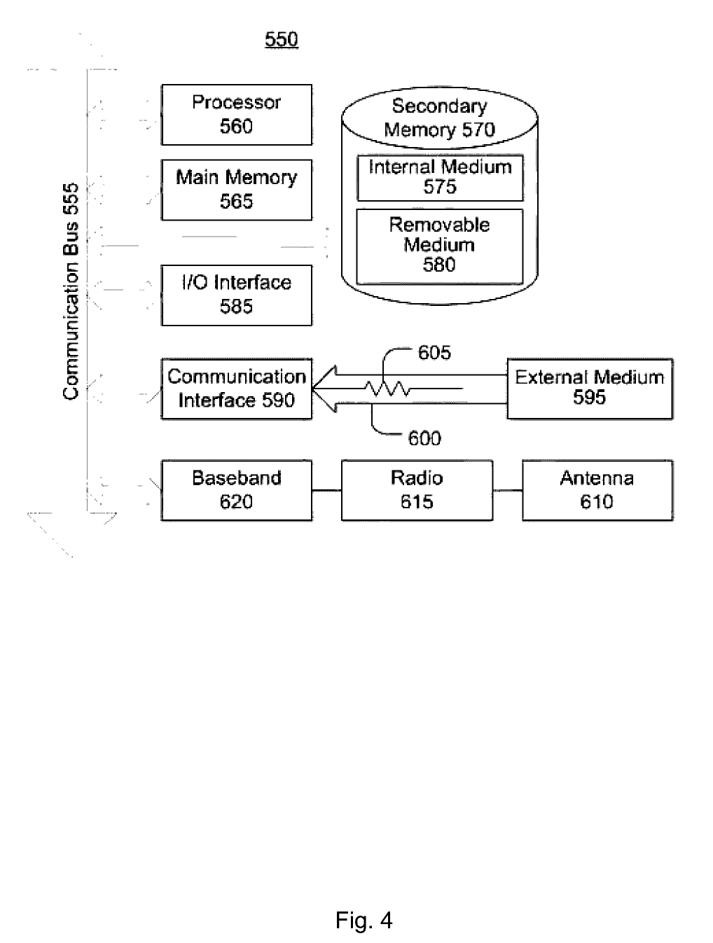

FIG. 4 is a block diagram illustrating an example wired or wireless system 550 that may be used in connection with various embodiments described herein. For example the system 550 may be used as or in conjunction with a patient unit, physician unit, specialist unit, or consult server as previously described with respect to FIGS. 1, 2, and 3. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present disclosure as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In one embodiment, the system 550 includes a camera (not shown) that is capable of capturing still and/or videoimage data as part of a rich multimedia session. For example, the camera may allow the system 550 to send high quality still images to data storage and/or a peer communication device. The camera may also allow the system 550 to send high quality video to data storage and/or a peer communication device. In this fashion, the system 550 is capable of establishing and implementing a rich multimedia session with another communication device over a communication network.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present disclosure as previously described. For example, data storage areas 565 may include various software modules (not shown) that were previously described with respect to FIGS. 1, 2, and 3.

Various embodiments may also be implemented primarily in hardware using, for example, components such as application specific integrated circuits (“ASICs”), or field programmable gate arrays (“FPGAs”) Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the disclosure. In addition, the grouping of functions within a module, block, circuit or step is for ease of description. Specific functions or steps can be moved from one module, block or circuit to another without departing from the disclosure.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The basic structural relationship between patient units 100, physician units 120, and specialist units 125 are depicted in FIG. 1. Patient units 100, physician units 120, and specialist units 125 are all linked together by web-based system server 140 via the Internet for facilitating collaboration between the participants. In order to control the collaboration process, all communications between patient units 100, physician units 120, and specialist units 125 are passed through and controlled by server 140. There are no direct communications between patient units 100, physician units 120, and specialist units 125. Server 140 can simultaneously process multiple collaboration sessions.

Server 140 may be constructed of a variety of different applications including a conversion engine (to promote interoperability between units), an audio/video media engine, patient information management applications, and administrative applications. Additionally, server 140 may include several different standard server technologies: web server (which can be any commercially available web server application that provides web publishing functionality), mail server (which can be any commercially available secure mail server that provides SMTP mail functionality), database (which can be any specially configured commercial database), and media server (which can be any commercially available media server application that provides audio/video streaming functionality).

A core engine may control communications and interactions between all of the other applications on server 140 as well as communication between physician, patient, and specialist units.

The system may allow a patient, specialist, or physician to share numerous types of materials during a session with participants. Some of these materials include documents, images, movies, and questionnaires.

One embodiment of the patient interface is described herein. The patient may execute the telehealth application on their mobile phone. The user may then be prompted to login to the system. The user may also be given the option at any time to place an emergency call for medical assistance. The emergency call may route the patient to a local emergency response organization or a local hospital. Once logged in, the patient may have the option to enter a virtual waiting room. In order to enter the waiting room, the patient may have to provide information about their medical issue, including biographical information, geographical information, and medical history information. The patient may request physician contacts within a certain geographical area. The patient may also enter information regarding payment for the consultation, such as insurance information or electronic payment information. The patient may be able to schedule sessions with physicians or specialists in the waiting room.

The patient interface may utilize on-board sensors to retrieve medical diagnostic information from the patient prior to or during the consultation. For example, the patient unit may capture the patient's heart rate and automatically transmit that medical diagnostic information to the physician. Other examples include using the patient unit to detect blood pressure and temperature and transmitting that medical diagnostic information to the physician (or specialist).

The system includes an automated advertisement placement capability to provide the opportunity for direct consumer marketing. The advertisements have active http links to designated URL's. The automated advertisement feature may provide contextual advertisements to the patient based on information they provide to the application. For example, if the patient reports cold or flu-like symptoms, the automated advertisement feature may place ads related to pharmaceutical products treating these symptoms. In another example, if the patient is reported muscle pain or soreness, the advertisement feature may place ads related to massage and other similar treatments.

The patient waiting room may contain space for one or more advertising links. Any image or animation can be inserted here along with a hyperlink to any desired web site. The advertising images are added from the backend management tools of the system when the session is setup. The advertisements are used to direct participants to any web-based content, or for specific e-commerce opportunities.

The system allows the addition of advertisements to a company's database for use in future sessions. The ads can be any standard image type, logo, or photograph combined with a hyperlink to any live web site.

When the patient clicks on an advertisement, that user may have a new browser window open. The new browser will be directed to the URL specified by the presenter when the session was setup. The user can then navigate the new browser, as appropriate.

In order to control the transmission and reception of the live audio/video stream, server 140 using a media engine must administer an encoder at both the broadcasting unit (possibly patient unit 100, specialist unit 125, or physician unit 120) and recipient units via the Internet. With audio/video steaming, multiple units may be broadcasting to each other simultaneously. Media streaming may be facilitated by the creation of an IP tunnel between the patient unit, the physician unit, and the specialist unit through server 140. While server 140 facilitates the IP tunnel, server 140 may not process the live audio stream during audio/video communications.

Although the present disclosure has been described with respect to one or more particular embodiments, it will be understood that other embodiments of the present disclosure may be made without departing from the spirit and scope of the present disclosure. Hence, the present invention is deemed limited only by the appended claims and the reasonable interpretation thereof.

What is claimed is:

1. A system for computerized patient access and care management comprising:
a user endpoint device having a display and an audiovisual receiver in communication with a processor;
a physician endpoint device having a display and an audiovisual receiver in communication with a processor;
a specialist endpoint device having a display and an audiovisual receiver in communication with a processor; and
a care management server in electronic communication with the user endpoint device, the physician endpoint device, and the specialist endpoint device, the care management server in electronic communication with:
one or more electronic user authentication databases;
one or more electronic patient information databases; and
one or more electronic physician information databases;
wherein the processor of the user endpoint device is configured to:
authenticate a patient by transmitting authentication data received at the user endpoint device to the care management server;
transmit a multimedia session request to the care management server;
receive a set of available physicians for a multimedia session;
negotiate the multimedia session with the physician endpoint device via the care management server;
transmit audiovisual data to the physician endpoint device from the audiovisual receiver of the user endpoint device; and
receive and display audio visual data from the physician endpoint device using the display of the user endpoint device;
wherein the processor of the physician endpoint device is configured to:
authenticate a physician by transmitting authentication data received at the physician endpoint device to the care management server;
negotiate a request for the multimedia session with the authenticated user endpoint device via the care management server;
receive patient history data from the care management server corresponding to the authenticated patient;
transmit audiovisual data to the user endpoint device from the audiovisual receiver of the physician endpoint device;
receive and display audio visual data from the user endpoint device using the display of the physician endpoint device;
during the multimedia session, transmit a second multimedia session request to the care management server;
receive a set of available specialists for the multimedia session from the care management server; and
negotiate the multimedia session with the specialist endpoint device via the care management server;
wherein the processor of the specialist endpoint device is configured to:
authenticate a specialist by transmitting authentication data received at the specialist endpoint device to the care management server;
negotiate a request for the multimedia session with the authenticated physician endpoint device and the authenticated user endpoint device via the care management server;
receive patient history data from the care management server corresponding to the authenticated patient;
transmit audiovisual data to the physician endpoint device and the user endpoint device from the audiovisual receiver of the specialist endpoint device; and
receive and display audio visual data from the user endpoint device and physician endpoint device using the display of the specialist endpoint device; and
wherein the care management server is configured to:
receive authentication data from the user endpoint device, physician endpoint device, or the specialist endpoint device;
compare the received authentication data to the one or more user authentication databases;
transmit an authentication signal to the user endpoint device, physician endpoint device, or the specialist endpoint device from which the authentication data was received;
receive a multimedia session request from the user endpoint device;
transmit to the user endpoint device a set of available physicians from the one or more physician information databases corresponding to one or more authenticated physician endpoint devices;
transmit to the physician endpoint device patient history data from the one or more patient information databases corresponding to the authenticated patient
receive a multimedia session request from the physician endpoint device;
transmit to the physician endpoint device a set of available specialists from the one or more physician information databases corresponding to one or more authenticated specialist endpoint devices; and
transmit to the specialist endpoint device patient history data from the one or more patient information databases corresponding to the authenticated patient.

2. The system of claim 1, wherein the processor of the user endpoint device is configured to provide patient history data to the authenticated patient using the display of the user endpoint device.

3. The system of claim 2, wherein the processor of the user endpoint device is configured to:
receive new patient history from the user endpoint device; and
transmit the new patient history to the care management server; and
wherein the processor of the care management server is configured to:
receive the new patient history from the user endpoint device;
process the new patient history according to pre-determined business rules; and
store the processed new patient history in the one or more patient information databases.

4. The system of claim 1, wherein the patient information database contains insurance information corresponding to each patient.

5. The system of claim 4, wherein the processor of the care management server is configured to:
analyze the insurance information with respect to pre-determined business rules to determine if the patient is qualified for free medical care.

6. The system of claim 1, wherein during the negotiation of the multimedia session with the physician endpoint device via the care management server, the processor of the care management server is configured to place the authenticated patient in a session queue.

7. The system of claim 6, wherein during the negotiation of the multimedia session with the physician endpoint device via the care management server, the processor of the care management server is configured to transmit the session queue to one or more authenticated physician endpoint devices and receive a selection corresponding to a patient in the session queue from the one or more authenticated physician endpoint devices.

8. The system of claim 1, wherein the care management server receives updated patient history information from the physician endpoint device or the specialist endpoint device and stores the updated patient history information in the one or more patient information databases.

9. The system of claim 1, further comprising a medical diagnostic device in electronic communication with the user endpoint device, the medical diagnostic device configured to provide real time patient information to the user endpoint device.

10. The system of claim 9, wherein the user endpoint device is further configured to transmit the real time patient information from the medical diagnostic device to the care management server.

11. The system of claim 1, wherein the care management server is configured to receive prescription requests from the physician endpoint device or the specialist endpoint device.

12. The system of claim 1, wherein the user endpoint device is configured to receive geographic location and transmit the geographic location to the care management server.
